(19) United States
(12) Patent Application Publication
(10) Pub. No.: US 2006/0181376 A1
(43) Pub. Date: Aug. 17, 2006

(54) Electromagnetic relay

(76) Inventors: Rudolf Mikl, Arbesthal (AT); Johann Loy, Kapellerfeld (AT)

Correspondence Address: BARLEY SNYDER, LLC, 1000 WESTLAKES DRIVE, SUITE 275, BERWYN, PA, 19312, US

(21) Appl. No.: 11/304,224

(22) Filed: Dec. 15, 2005

(30) Foreign Application Priority Data
Dec. 15, 2004 (DE) 102004060370.7

(51) Int. Cl. H01H 51/22

(52) U.S. Cl. 335/78; 200/83 L

(57) ABSTRACT

The invention relates to an electromagnetic relay comprising a changeover contact and a working contact, the changeover contact abutting an stop in the open position. The changeover contact interacts via a slide member with an armature plate, which is arranged on a different side of the coil, opposite the changeover contact. The stop comprises an abutment surface, which is arranged below contact buttons of the changeover contact and abuts the changeover contact below the contact buttons in the open position. Improved activation behavior of the relay is achieved as a result of this position of the abutment surface. The useful life of the relay is also lengthened as a result of this embodiment of the stop.

### FIELD OF THE INVENTION

The invention relates to an electromagnetic relay and more particularly to a contact and stop arrangement.

### BACKGROUND

Electromagnetic relays are known in a wide variety of embodiments. International patent application WO 00/24019, for example, discloses an electromagnetic relay comprising a base that defines a base plane, and a magnet system that is arranged on the base and comprises a coil, a core and an armature. The relay also comprises a pair of normally open contacts and at least one pair of normally closed contacts, each pair of contacts having an active and a passive spring contact. Each spring contact is secured in the base, standing substantially perpendicularly to the base plane, and has a contact piece at its end that is remote from the base. An actuating slide, is coupled to the armature, is movable to the base plane and interacts with the spring contact.

An electromagnetic relay as illustrated in FIG. 4 is already known in the prior art. The known relay has a contact arrangement comprising a changeover contact 6, a working contact 5 and an stop 7. The stop 7 comprises an abutment surface, which is arranged level with contact buttons 13 of the changeover contact 6. As a result of this arrangement, the contact buttons 13 of the changeover contact 6 strike the abutment surface of the stop 7 in the open position of the relay. The elevated position of the stop 7 has the advantage that the changeover contact 6 is spared, as it is the contact buttons 13 of the changeover contact 6 that enter into abutment with the stop 7. However, it is desirable to develop a stop arrangement which results in improved long-term stability of the relay.

### SUMMARY

The invention provides an electromagnetic relay having a coil, an armature and a yoke. The relay includes a working contact with a contact button and a changeover contact also having a contact button and being movable between open and closed positions. The contact button of the changeover contact engages the contact button of the working contact in the closed position and disengages therefrom in the open position. A stop has an abutment surface which, in the open position, is engaged by the changeover contact below its contact button.

### BRIEF DESCRIPTION OF THE DRAWINGS

The invention will be described below in greater detail with reference to the figures, in which:

FIG. 1 is a perspective view of a relay according to an embodiment of the invention;

FIG. 2 is a perspective view showing the stop comprising the changeover and working contacts;

FIG. 3 is a side view showing the base comprising the mounted changeover contacts, the working contacts and the stop; and

FIG. 4 is a perspective view showing a relay according to the prior art.

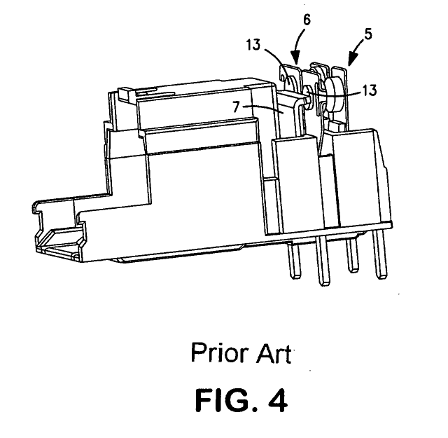

### DETAILED DESCRIPTION OF AN EMBODIMENT

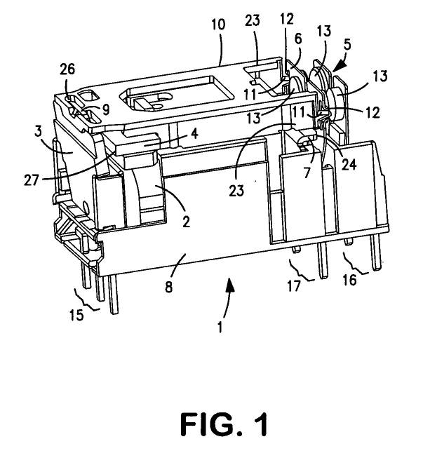

FIG. 1 is a perspective view of an electromagnetic relay 1, which substantially comprises a base 8, a coil 2, an armature plate 3 and a yoke 4. The armature plate 3 interacts with a changeover contact 6 via a slide member 10. The changeover contact 6 is arranged on the coil 2 opposite the armature plate 3. A working contact 5 is associated with the changeover contact 6. In the illustrated embodiment, the changeover contact 6 and the working contact 5 are configured as spring contacts, in particular as double spring contacts. The changeover contact 6 and the working contact 5 may also be configured as other types of contacts. The working contact 5 and the changeover contact 6 are inserted into the base 8 and are in this way fastened to the base 8.

The armature plate 3 is also inserted into the base 8, but is secured in the base 8 in a tilting manner. At its upper end, the armature plate 3 has a projection 9, which is inserted into a locking opening 26 in the slide member 10 and is connected to the slide member 10 via a locking connection. The slide member 10 is placed on the base 8 and is mounted on the base 8 such that it is displaceable parallel to the longitudinal axis of the coil 2. The slide member 10 has a respective arbor projection 11, located opposite the locking opening 26 on each of two lateral edges. In the illustrated position, the arbor projections 11 engage with receiving openings 12 in the changeover contact 6. The receiving openings 12 are formed, in each case on the outside of the changeover contact 6, next to the contact buttons 13. The working contact 5 also has a contact button 13 in each spring element. The contact buttons 13 of the working contact 5 and of the changeover contact 6 are arranged level with one another, so an electrical contact is achieved, during closure of the relay 1, via abutment of the contact buttons 13 of the working contact 5 and of the changeover contact 6.

A stop 7, with which the changeover contact 6 enters into abutment in an open position of the relay 1, is also arranged between the coil 2 and the changeover contact 6. The stop 7 comprises an abutment surface 24, which is configured below the contact buttons 13 of the changeover contact 6 and enters into abutment with the changeover contact 6 below the contact buttons 13 in the open position of the relay 1. In a further embodiment, the changeover contact 6 is in the form of a double spring contact and may be biased with respect to the stop 7 with a predetermined bias.

In the region of the changeover contact 6, the slide member 10 comprises a respective frame 23, on which the arbor projection 11 is configured, on opposing side regions. The frames 23 are arranged, in each case, above the stop 7. Because of the low configuration of the stop 7, abutment of the changeover contact 6 with the entire width of the stop 7 is possible, and there is also sufficient space for the formation of the frames 23. The frames 23 are arranged above the stop 7.

In the illustrated embodiment, the stop 7 is in the form of an angled plate having an angled portion 14 extending transversely over the entire changeover contact 6, so the entire width of the changeover contact 6 enters into abutment with the angled portion 14. In the illustrated embodiment of the double spring contact for the changeover contact 6, both spring elements of the changeover contact 6 enter into abutment with the stop 7. A uniform abutment of the changeover contact 6 is thereby achieved, so the changeover contact 6 is spared during striking of the stop 7.

The yoke 4 is configured as a U-shaped yoke comprising two yoke arms, one yoke arm (not shown) being guided through the centre of the coil 2 forming the core of the coil 2. The second yoke arm 27 is guided out of the coil 2, in the region of the stop 7, and is guided along the coil 2 into the region of the armature plate 3. In its lower region, the armature plate 3 is placed against the core of the coil 2, the upper region being arranged at a distance from the second yoke arm 27 in the open position of the relay 1.

If the coil 2 is then supplied with current via electrical terminals 15, the upper region of the armature plate 3 is drawn toward the second yoke arm 27, tilting the armature plate 3 toward the coil 2. The axis of rotation is arranged in the region of the base 8. As a result of the tilting movement, the slide member 10 is moved toward the changeover contact 6. Because of the movement of the slide member 10, the arbor projections 11 engage, after a free section, with the receiving openings 12 and push the changeover contact 6 toward the working contact 5. The contact button 13 of the changeover contact 6 enters into mechanical contact with the contact buttons 13 of the working contact 5. An electrically conductive connection between the working contact 5 and the changeover contact 6 is thus produced. The working contact 5 comprises first electrical terminals 16 and the changeover contact 6 second electrical terminals 17, which are guided out of the base 8 on the lower side.

If current is then removed from the magnetic coil 2, the armature plate 3 is moved by means of an armature spring (not shown) back into the starting position, as a result of which the slide member 10 is also moved back into the starting position again. The arbor projections 11 are moved out of the receiving openings 12, so the resiliently configured changeover contact 6 also swings back into the starting position. The changeover contact 6 strikes the stop 7 and enters into abutment with the stop 7.

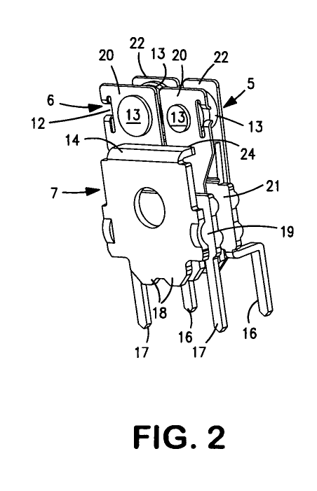

FIG. 2 is a perspective view of the arrangement of the stop 7, the changeover contact 6 and the working contact 5. In this illustration, the working contact 5, the changeover contact 6 and the stop 7 are illustrated in the same position in which the components are integrated in the relay 1. The stop 7 is substantially in the form of a plate, on the upper edge region of which an angled portion 14 is integrally formed in the direction toward the changeover contact 6. In the integrated state, insertion portions 18 of the stop 7 are inserted into a base plate of the base 8 and fastened to the base 8. The receiving openings 12 are in the form of curved tabs, formed laterally on the contact buttons 13. The changeover contact 6 consists substantially of a contact plate 19, on which the second electrical terminals 17 are integrally formed. Two spring elements 20 in the form of spring plates, which extend upward and are arranged side by side, are fastened to the contact plate 19.

The working contact 5 consists of a second contact plate 21, from the lower side of which the first electrical terminals 16 are guided out. Two second spring elements 22 in the form of spring plates, which are arranged side by side and are guided out upwardly via the second contact plate 21, are fastened to the second contact plate 21. The first and the second spring elements 20, 22 are arranged substantially parallel to one another, the contact buttons 13 being fastened in the first and second spring elements 20, 22.

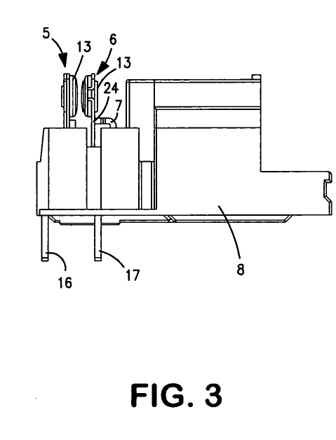

FIG. 3 is a schematic side view of the base 8 and the contact arrangement comprising the working contact 5 and the changeover contact 6. The changeover contact 6 abuts an abutment surface 24 of the stop 7. For the sake of clarity, the further elements of the relay 1 are not shown in the illustration of FIG. 3. In the illustrated position, the changeover contact 6 is in the open-position, in which there is no electrical contact between the working contact 5 and the changeover contact 6. In this position, the changeover contact 6 abuts the stop 7 with a defined bias, the stop 7 directly abutting the spring plates 20 of the changeover contact 6 below the contact buttons 13.

The arrangement of the stop 7, with the plate part 14 below the contact buttons 13 of the changeover contact 6, results in improved activation of the changeover contacts 6.

An advantage of the relay 1 consists in the fact that the changeover contact 6 enters into abutment with an stop7 in the open position, the stop 7 being arranged below the contact button 13 of the changeover contact 6. Improved functioning of the electromagnetic relay 1 is surprisingly achieved in this manner. As a result of the abutment of the changeover contact 6 with the stop 7 below the contact button 13, both the mechanical and the electrical functioning of the relay 1 is improved. In particular, improved switching properties of the relay 1 are achieved. Tests have revealed that the long-term stability of the relay is increased by 30%.

The changeover contact 6 may be formed as a spring contact, in particular a double spring contact. In this embodiment, the spring metal sheet enters into abutment with the stop 7 in the open position of the changeover contact 6. The spring metal sheet provides, on the one hand, the desired resilient function and, on the other hand, sufficient mechanical strength, which is required for the changeover contact 6.

In the embodiment described, the angled portion 14 of the stop 7 extends over the entire width of the changeover contact 6. Uniform abutment of the changeover contact 6 with the stop 7 is thereby achieved. This results, advantageously, in less wear to the changeover contact.

What is claimed is:

1. An electromagnetic relay having a coil, an armature and a yoke, the relay comprising:
a working contact having a contact button;
a changeover contact having a contact button and being movable between open and closed positions, wherein the contact button of the changeover contact engages the contact button of the working contact in the closed position and disengages therefrom in the open position; and
a stop having an abutment surface which, in the open position, is engaged by the changeover contact below its contact button.

2. The relay of claim 1 wherein the changeover contact is in the form of a spring contact.

3. The relay of claim 1 wherein the working contact is in the form of a spring contact.

4. The relay of claim 1 wherein the changeover contact and the working contact are configured as a double spring contact.

5. The relay according of claim 1 wherein the armature is in the form of an armature plate and is arranged on the coil opposite the changeover contact.

6. The relay of claim 1 wherein the stop is an angled plate.

7. The relay of claim 6 wherein the abutment surface extends over the entire width of the changeover contact.
